(19) United States
(12) Patent Application Publication
(10) Pub. No.: US 2023/0259999 A1
(43) Pub. Date: Aug. 17, 2023

(54) METHODS AND SYSTEMS FOR ON-PLATFORM TRANSACTIONS

(71) Applicant: QVC, Inc., West Chester, PA (US)

(72) Inventors: Matthias Edler, West Chester, PA (US); Randy Ridge, St. Petersburg, FL (US); Blaise Lipan, St. Petersburg, FL (US)

(21) Appl. No.: 18/170,353

(22) Filed: Feb. 16, 2023

Related U.S. Application Data
(60) Provisional application No. 63/310,700, filed on Feb. 16, 2022.

(51) Int. Cl. G06Q 30/0601; H04N 21/4722; H04N 21/658

(52) U.S. Cl. CPC G06Q 30/0623; G06Q 30/0639; G06Q 30/0641; H04N 21/4722; H04N 21/6581

(57) ABSTRACT

Methods and systems for on-platform purchases are described. A client device may, based on brand information or product information associated with primary content or secondary content, request additional product information.

### CROSS REFERENCE TO RELATED APPLICATION

This application claims the priority benefit of U.S. Provisional Application No. 63/310,700, filed Feb. 16, 2022, the entirety of which is incorporated herein by reference.

### BACKGROUND

Users viewing content on a device may wish to purchase items in the content. However, the cumbersome task of identifying an item in the content, locating the item for sale (e.g., on a website operated by a third party seller), and placing an order for the item through the third party seller rather than the platform on which the item was initially seen degrades the user experience. A more expedient manner of purchasing items in content is needed.

### SUMMARY

It is to be understood that both the following general description and the following detailed description are exemplary and explanatory only and are not restrictive or intended to be limiting. In some aspects, the methods and systems described herein offer one or more items for purchase based on a service infrastructure configured to consolidate information provided by one or more application program interfaces (APIs) associated with one or more brands into a standardized schema such that an end user of a streaming service has a seamless experience purchasing the one or more items. Additional advantages will be set forth in part in the description which follows or may be learned by practice. The advantages may be realized and attained by means of the elements and combinations particularly pointed out in the appended claims.

### BRIEF DESCRIPTION OF THE DRAWINGS

The accompanying drawings, which are incorporated in and constitute a part of this specification, show examples and together with the description, serve to explain the principles:

FIG. 1 shows an example system;

FIG. 2 shows an example system;

FIG. 3 shows an example method;

FIG. 4 shows an example method;

FIG. 5 shows an example method; and

FIG. 6 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information.” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

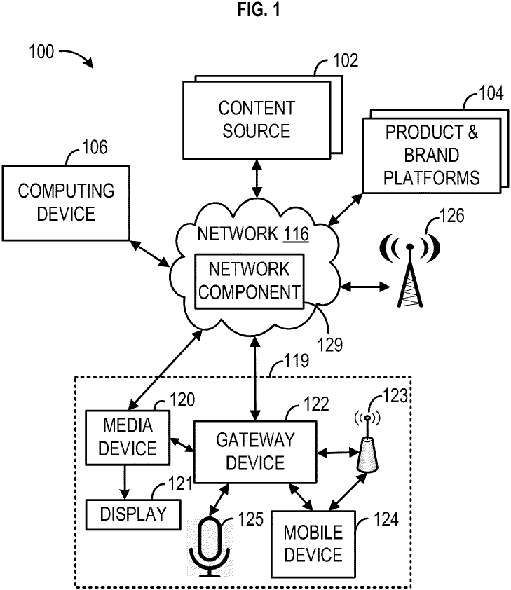

The present disclosure relates to methods and systems for delivering and managing content. FIG. 1 shows a system 100 for content distribution. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a content source 102, a computing device 106, a distribution device 126, a media device 120, a gateway device 122, a mobile device 124, and an audio device 125 (e.g., a smart speaker). Each of the content source 102, the computing device 106, the product and brand platforms 104, the media device 120, the gateway device 122, and/or the mobile device 124, can be one or more computing devices, and some or all of the functions performed by these components may at times be performed by a single computing device. The content source 102, the product and brand platforms 104, the computing device 106, the media device 120, the gateway device 122, and/or the mobile device 124 may be configured to communicate through a network 116. The network 116 may facilitate sending content to and from any of the one or more device described herein. For example, the network may be configured to facilitate the content source 102 sending primary content and/or secondary content to one or more of the media device 120, the gateway device 122, and/or the mobile device 124.

The network 116 may be a content delivery network, a content access network, combinations thereof, and the like. The network may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like. The network component 129 may be any device, module, combinations thereof, and the like communicatively coupled to the network 116. The network component 129 may also be a router, a switch, a splitter, a packager, a gateway, an encoder, a storage device, a multiplexer, a network access location (e.g., tap), physical link, combinations thereof, and the like.

The content source 102 may be configured to send content (e.g., video, audio, movies, television, games, applications, data, etc.) to one or more devices such as the media device 120, a network component 129, a first access point 123, a mobile device 124, an audio device 125, a distribution device 126, and/or the media device 120. The content source 102 may be configured to send streaming media, such as broadcast content, video on-demand content (e.g., VOD), content recordings, combinations thereof, and the like. For example, the content source 102 may be configured to send primary content (e.g., television, movies, combinations thereof, and the like) and secondary content (e.g., one or more advertisements, metadata, combinations thereof, and the like), via the network 116, to, for example, one or more of the media device 120, the mobile device 124, and/or the audio device 125.

The content source 102 may be managed by third party content providers, service providers, online content providers, over-the-top content providers, combinations thereof, and the like. The content may be sent based on a subscription, individual item purchase or rental, combinations thereof, and the like. The content source 102 may be configured to send the primary content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The content source may be configured to receive, send, generate, store, or otherwise process one or more manifest files and/or one or more program map tables (PMTs). For example, the content source 102 may be configured to send to or receive from one or more of the computing device 106, the product and brand platforms 104, and/or any of the devices at premises 119 (e.g., the media device 120, the gateway device 122, the mobile device 124, and/or the audio device 125), the one or more manifest files and/or the one or more PMTs.

The one or more manifest files may, for example, comprise timing data, one or more file names, one or more paths, one or more file locations, one or more file sizes, one or more file dependencies, package metadata, one or more installation instructions, combinations thereof, and the like. The media device 120, may for example be configured to send one or more requests for content based on the one or more manifest files. The one or more manifest files may comprise production information, brand information, item information, product airing information, combinations thereof, and the like. For example, the one or more manifest files may include brand information and/or product information associated with one or more segments of content. For example, a URL associated with a segment of content may indicate a brand or product featured in that segment of content.

Depending on the content, metadata included in the content may be related to one or more applications. For example, the manifest file may indicate a name of the application, a brand associated with the application, a version of the application, an author, the permissions required by the application, the main activity class of the application, and any other configuration information needed to properly run the application.

The content source 102 may be configured to send one or more PMTs. A PMT may comprise a data structure configured to describe the elementary streams that make up content (e.g., a broadcast program). The PMT may contain information about the type of data (audio, video, subtitle, etc.), codec used for encoding, and other relevant information needed for the decoder to properly process the stream. The PMT may be part of the MPEG-2 transport stream and may be used by a digital TV receiver (e.g., the gateway device 122) to identify and decode various elements of, for example, a TV program.

The PMT may be organized as a table, with each row of the table describing a single program in the transport stream. The PMT may include one or more program numbers (e.g., program IDs or “PIDs”). The one or more PIDs may be one or more unique identifiers identifying the program being described by the PMT. The PMT may comprise one or more Program Clock References (PCRs). The one or more PCRs may comprise timing data configured to synchronize audio, video, or other streams or data. The PMT may contain descriptive information such as a program name, genre, characters, subject matter, or other metadata. The PMT may comprise elementary stream information configured to describe the individual audio, video, and data streams in the program, including the type of data, the PID, and the codec used.

The one or more PMTs may comprise production information, brand information, item information, product airing information, combinations thereof, and the like. For example, the one or more PMTs may include brand information and/or product information associated with one or more segments of content for example in a program title, program number, PID, or in conditional access system (CAS) information. For example, a program title may indicate a brand.

Depending on the content (e.g., PMT and/or manifest file), metadata included in the content may be related to one or more applications. For example, the manifest file may indicate a name of the application, a brand associated with the application, a version of the application, an author, the permissions required by the application, the main activity class of the application, and any other configuration information needed to properly run the application.

One or more of the devices at the premises may be configured to cause an application to launch based on the information in the manifest file and/or the PMT. For example, a brand may be associated based on a program title. For example the media device 120 may be configured to determine the brand information, and launch a corresponding application. Launching the application may comprise outputting one or more interface elements via the display device 121. The one or more interface elements may comprise interactive interfaces configured to receive one or more user inputs.

The content source 102 may be configured to send secondary content (e.g., video, audio, movies, television, games, applications, data, etc.) to one or more devices such as the media device 120, the gateway device 122, the network component 129, the first access point 123, the mobile device 124, the audio device 125, and/or the distribution device 126. The content source 102 may comprise, for example, a content server such as an advertisement server. Secondary content may comprise, for example, advertisements (interactive and/or non-interactive) and/or supplemental content such as behind-the-scenes footage or other related content, supplemental features (applications and/or interfaces) such as transactional applications for shopping and/or gaming applications, metadata, combinations thereof, and the like. The metadata may comprise, for example, demographic data, pricing data, timing data, configuration data, combinations thereof, and the like. For example, the configuration data may include formatting data and other data related to delivering and/or outputting the secondary content.

The content source 102 may be configured to send streaming media, such as broadcast content, video on-demand content (e.g., VOD), content recordings, combinations thereof, and the like. The secondary content source 104 may be managed by third party content providers, service providers, online content providers, over-the-top content providers, combinations thereof, and the like. The content may be sent based on a subscription, individual item purchase or rental, combinations thereof, and the like. The content source 102 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The content source 102 may be configured to send the secondary content based on, for example, one or more requests received from devices at a premises 119 including, for the example, the media device 120, the gateway device 122, the mobile device 124, or the audio device 125). For example, the media device 120 may request secondary content based on a manifest file, a program map table (e.g., PMT table), in-line signaling such as SCTE-35 signaling, combinations thereof, and the like. For example, the secondary content source may send secondary content comprising audio data to, for example, the media device 120. The secondary content may, en route between the secondary content source 104 and the media device, be routed through the distribution device 126. The distribution device 126 may comprise, for example, a cable headend.

The media device 120 may be configured to receive the content (e.g., primary content and/or secondary content). The media device 120 may comprise a device configured to enable an output device (e.g., a display, a television, a computer or other similar device) to output media (e.g., content). For example, the media device 120 may be configured to receive, decode, transcode, encode, send, and or otherwise process data and send data to, for example, the display device 121. For example, the media device 120 may be configured to receive the one or more manifest files and/or the one or more PMTs.

The media device 120 may be configured to send one or more requests for content based on the one or more manifest files. The one or more manifest files may, for example, comprise timing data, one or more file names, one or more paths, one or more file locations, one or more file sizes, one or more file dependencies, package metadata, one or more installation instructions, combinations thereof, and the like. The media device 120, may for example be configured to send one or more requests for content based on the one or more manifest files and/or one or more PMTs. Similarly, the mobile device 124 and/or the audio device 125 may be configured to receive and process primary and secondary content.

The media device 120 may be configured to determine brand information and/or platform information associated with the primary content and/or the secondary content. For example, the media device 120 may be configured receive, store, and process the one or more manifest files and/or one or more PMTs to determine, for example, a brand and/or item associated with a segment of primary content and/or secondary content. The media device may be configured to output one or more interface elements based on the brand information in the primary content and/or the secondary content. For example, based on determining one or more URLs in a manifest file indicate a content segment is located at a resource associated with one or more brands (e.g., QVC, HSN, AMAZON, FENDI, or any other brand), the media device may launch an application associated with the brand. For example, the media device 120 may launch a QVC shopping application configured to facilitate the purchase of one or more items associated with one or more brands.

Based on the user input, the media device 120 (e.g., a “client device”) may send one or more requests (e.g., one or more calls). The one or more calls may be formatted according to one or more first formats. For example the primary content source 102 may be one or more streaming services (e.g., ROKU, APPLE TV, FIRE TV, combinations thereof, and the like). For example, the one or more calls from the client may be GraphQL calls. The one or more first formats may be associated with the primary content source (e.g., one or more streaming platforms as discussed below). For example, one or more calls may request only data required by the client device. For example, a client device (e.g., media device 120, mobile device 124, may indicate to the computing device, the requested data. The one or more calls may be associated with a single endpoint. GraphQL is a query language, which means that clients can send requests to a server using a specific syntax that describes the data they need. The server then responds with data that matches the request. One of the benefits of GraphQL is that it provides a strongly-typed schema, which means that the data types and structures of the data available through the API are defined in advance. This makes it easier for clients to understand and work with the data. Another advantage of GraphQL is that it allows clients to request multiple resources in a single request, reducing the number of round trips needed to get all the data. It also allows for real-time updates, making it useful for building applications that require frequent updates and data synchronization. GraphQL provides a more flexible and efficient way to retrieve and manipulate data than traditional REST APIs, making it a popular choice for building modem web and mobile applications.

The one or more calls may be made to the computing device 106. The computing device 106 may be configured to receive the one or more calls in the first format, and send one or more replies, based on the one or more calls, in a common format. The one or more calls may be converted to GraphQL by an intelligent edge platform as described below. For example, a streaming service accessed by the media device 120 may call into the computing device 106 via RESTful (Representational State Transfer) calls, WCF (Windows Communication Foundation) client connections, SOAP (Simple Object Access Protocol), XML-PRC, JSON-RPC, gRPC, Apache Thrift, Apache CXF, Spring Web Services, combinations thereof, and the like. The reply to the call may include product and brand information such as product availability and pricing.

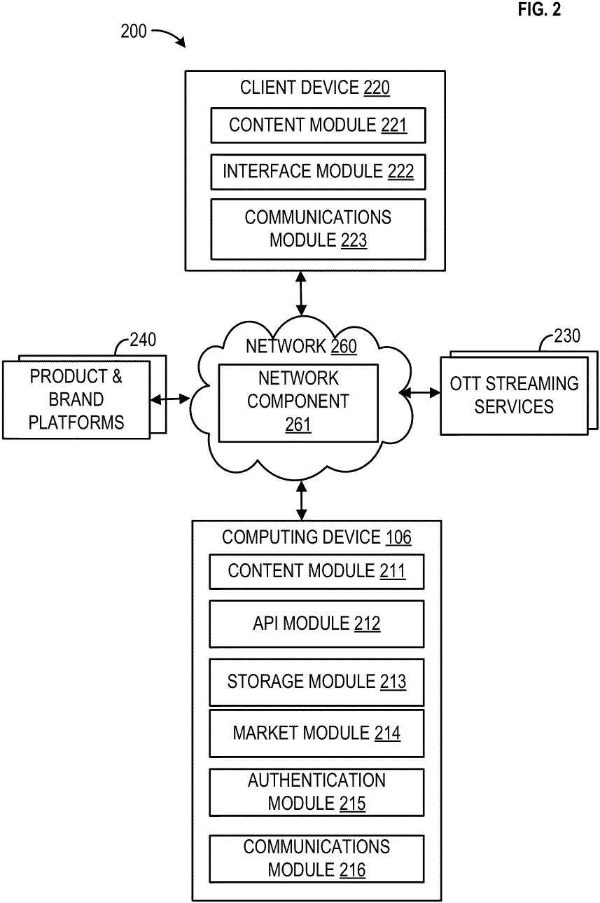

FIG. 2 shows an example system 200 for on-platform purchases. The system 200 may comprise the computing device 106, a client device 220, one or more streaming services 230, and one or more brand platforms 240 (e.g., the one or more brand and product platforms 104). The computing device 106, the client device 220, the one or more streaming services 230, and the one or more brand platforms 240 may be configured to communicate via a network 260. The network may be managed (e.g., provided, deployed, serviced) by a content provider, a service provider, a merchant, combinations thereof, and the like. The network 260 may be a content delivery network, a content access network, combinations thereof, and the like. The network 260 may be managed (e.g., deployed, serviced) by a content provider, a service provider, combinations thereof, and the like. The network 260 may be an optical fiber network, a coaxial cable network, a hybrid fiber-coaxial network, a wireless network, a satellite system, a direct broadcast system, or any combination thereof. The network 260 can be the Internet. The network 260 may have a network component 261. The network component 261 may be any device, module, combinations thereof, or the like communicatively coupled to the network 260. The network component 261 may be a router, a switch, a splitter, a packager, a gateway, an encoder, a storage device, a multiplexer, a network access location (e.g., tap), physical link, combinations thereof, and the like. The client device 220 may be, for example, any of the devices at premises 119 (e.g., the media device 120, the mobile device 124, and/or the audio device 125).

The computing device 106 may comprise a content module 211, an application program interface (API) module 212, a storage module 213, market module 214, an authentication module 215, and a communications module 216. The computing device 106 may be configured to store, generate, analyze, send, receive, and/or otherwise process data. The computing device 106 may be configured to offer any kind of items for purchase based on a service infrastructure that consolidates information provided by various APIs from different brands into a standardized schema so that the end user of the one or more streaming services 230 may purchase products. For example, the user may purchase products from a brand such as QVC or HSN or any other brand/partner that might be included in a portfolio stored in the storage module 213.

The computing device 106 be configured to send streaming media, such as broadcast content, video on-demand content (e.g., VOD), content recordings, combinations thereof, and the like. The computing device 106 may be managed by third party content providers, service providers, online content providers, over-the-top content providers, combinations thereof, and the like. The content may be sent based on a subscription, individual item purchase or rental, combinations thereof, and the like. The content module 211 may be configured to send the content via a packet switched network path, such as via an IP based connection. The content may comprise a single content item, a portion of a content item (e.g., content fragment), one or more content items, a content stream, a multiplex that includes several content items, combinations thereof, and the like. The content may be accessed by users via applications, such as mobile applications, television applications, set top box (STB) applications, gaming device applications, combinations thereof, and the like. An application may be a custom application (e.g., created by and/or otherwise associated with a content provider, configured for a specific device, etc), a general content browser (e.g., web browser), an electronic program guide, combinations thereof, and the like.

The content may comprise one or more content segments. The one or more content segments may be associated with one or more content segment identifiers. For example, each content segment of the one or more content segments may be associated with a content segment identifier. The content may comprise one or more items for purchase. For example, the content may comprise one or more advertisements (or any other content) featuring the one or more items for purchase. An association between the one or more content segments and one or more items for purchase may be determined.

The computing device 106 may be configured to aggregate one or more underlying APIs. For example, the Application Programming Interface (API) module 212 may be configured to aggregate one or more APIs. The one or more APIs may contain different data contracts and means of accessing the API module methods via, for example, representational state transfer (e.g., RESTful) calls or Windows Communication Foundation (WCF) client connections. Data contracts may be responses from an API. The one or more data contracts may comprise one or more formal agreements between the client and the server about the format, structure, and type of data that will be exchanged between them. The one or more data contracts may specify one or more rules and/or one or more requirements for data exchange, including the data formats, data types, and data validation rules. The example, a data contract may define a set of data elements that will be passed between the client and server, and the expected values and constraints for each element. For example, the one or more data contracts can be expressed in various formats, such as JSON, XML, or Protocol Buffers, depending on the API design and requirements. For example, a JSON data contract might specify that a request should include a “item” field that must be a string and/or a “price” field that must be a date in a particular format.

The API module 222 may be configured to receive one or more calls. For example, one or more of the OTT streaming services 230 may call into the API module 222. The API module 222 may be configured to determine brand data and platform data associated with the call. The API module 222 may comprise an aggregation API. The aggregation API may determine a common format and may reply to the calling client in the common format. The common format may facilitate the client application to expect a single data object and be able to map this data response to one or more user interface elements. For example, the reply sent by the API module may be configured to cause output of one or more interface elements on a client device that originated the call (e.g., a client device that a user is using to access the one or more OTT streaming services 230). Thus, the client may request the response object that is needed by specifying in the query the exact fragments and data elements needed. This allows for client side processing to be standardized across the underlying systems that store and manage data in vastly different ways.

The API module 222 may be configured to receive one or more calls in one or more first formats, and send one or more replies in one or more second formats (e.g., a common format). For example, the API module 222 may be configured for data deserialization and data serialization. For example, the one or more client calls may comprise serialized data. For example, brand and platform information may be serialized. For example, the one or more client calls may comprise JSON or XML calls. The aforementioned are merely exemplary and explanatory. Any type of call may be used such as a GET, POST, PUT, DELETE, or any other calls.

The API module 222 may deserialize the brand and platform information. For example, the API module 222 may deserialize the one or more client calls and convert the request data from a first format to a second format (e.g., a common format).

The computing device 106 may be configured to implement one or more caching techniques. For example the computing device may comprise a storage module 213 (e.g., a cache). The computing device 106 may determine product, program, video, and CMS information associated with one or more brands and one or more platforms. For example, the one or more platforms may be queried to determine available content. For example, the one or more brands may be queried to determine available products. The computing device 106 may regularly query the one or more brands and one or more platforms to determine updated content and updated product information. For example, the storage module 213 may store first brand information and first platform information associated with a first time. As the API module 222 interfaces with the one or more brands and one or more platforms, the first brand information and the first platform information may be updated to second brand information and second platform information. One or more of the first brand information, the second brand information, the first platform information, and the second platform information may be stored in the storage module 213. Thus, API calls to origin may be reduced by repeatedly updating brand information and platform information. For example, when a request (e.g., a call is received), the cache may be queried rather than sending a call to origin. For example, the in-memory cache may be read from for each request and in the event a requested object is not currently stored in cache the application will go to origin to retrieve this information and then store in memory cache for a configurable amount of time.

The computing device 106 may be configured for real-time updates of product information and programming information. For example, the computing device 230 may be configured to communicate with many disparate data sources containing the product information, the programming information, combinations thereof, and the like. For example, item and programming information may be kept current (e.g., updated) and relevant to a specific point in live or video on demand content by way of real-time updates. For example, an update service may be configured to poll one or more data sources to determine the product information and the programming information. The update service may be configured to run on a fixed interval and aggregates data from multiple sources and stores in a cache in order to reduce source lookup. When an update is determined, one or more message may be sent to the one or more client devices. The one or more messages may be configured to update one or more interface elements at the one or more client devices. For example, one or more connections to one or more client devices, brand servers, product servers, platform servers, combinations thereof, and the like may be maintained by a transmission control protocol (TCP) operation running every 5 seconds to ensure the client application is still available.

The computing device 106 may comprise a market module 214. The market module 214 may be configured to associate items (e.g., products) with content (e.g., one or more media assets). Product airing algorithms and program guide schedules are used to tag the specific product at a specific timecode within a video on demand asset. The product airing algorithm may comprise a runlog of the items on air. Further, an optical character recognition (OCR) may be configured to read graphics data associated with one or more items in the content on air. Further, a manifest file may include the product airing information. For example, a program map table (PMT) may include the product airing information. The product information may indicate one or more products (e.g., one or more items, one or more services, one or more brands, etc...) associated with content. This information may be aggregated into the CMS system and stored in a memory cache. Thus, media assets and product offerings may be synchronized. The product airing information may be configured to trigger one or more events on the client device. For example, the product airing information may be configured to trigger one or more user interface updates. The one or more user interface updates may be configured to output information about products and services to the end user. For example, the one or more interface elements may be configured to allow the user to review and purchase the products associated with the content.

The market module 214 may be configured for order processing. For example, orders may be placed in the respective brands order systems and not stored in an aggregation data store. They may be created in real time in the related brand’s order system via the tagging and product number schematic that is managed at the API aggregation layer. There may be a common interface that is used by the client application that is then used to determine the proper API workflow to execute to the bag, customer, promotion and order management activities in order to validate viability of customer, item and shipment details.

The computing device 106 may comprise an authentication module 215. The authentication module 215 may be configured for managing one or more customer accounts. For example, the one or more customer accounts may be linked by leveraging the OAuth 2.0 standard for authorization and refresh token management. The customer may not be authenticated by default and the client application may use an authentication token value stored in a state management storage via a state management process configured to maintain and/or manipulate a state, or data, of a system or application. The state management process may be configured to keep track of user interactions, changes to data, and the status of different elements in the system, and ensuring that the system remains in a consistent state as it processes information and responds to user actions.

The authentication module 215 may be configured to determine if a customer is authenticated or not authenticated. If the customer is not authenticated a call to an identity server may be made to generate the data configured to provide the user a 6-digit device linking code as well as a quick read (QR) code that can be used to link to the relevant brand login information and/or device information to the customer account. The device linking code and/or the QR code may be sent to a user device associated with the customer (e.g., a television, computer, smart phone, or the like). The user may use a user device to complete the authentication process by, for example, scanning the QR code. Each brand may be uniquely managed from the customer and order management file perspective. The API module 212 may be configured to allow the client application to handle the same authentication flow for any brand by providing platform and brand management to drive the proper authentication and device linking information to the user interface.

The communications module 216 may be configured for multi-device communications sessions. The communications module 216 may be configured to send, receive, store, generate, or otherwise process data received from or sent to one or more other devices (e.g., the computing device 106, the one or more OTT streaming platforms 230 and/or the one or more brand platforms 240).

The client device 220 may be a media device like a set-top-box and/or a user device such as a smart phone, laptop, desktop computer, smart speaker, combinations thereof, and the like. The client device 220 may be configured to receive content. The media device 220 may be a digital streaming device, a gaming device, a media storage device, a digital recording device, a computing device, a mobile computing device (e.g., a laptop, a smartphone, a tablet, etc.), combinations thereof, and the like.

The client device 220 may comprise a content module 221. The content module 221 may be configured to receive, store, send, output, display, or otherwise process content. For example, the content module 221 may receive content from the computing device 210. The content module 221 may be configured to determine data associated with the content. For example, the content module 221 may be configured to process metadata associated with the content. The content module may be configured to receive and process an electronic programming guide (e.g., an EPG). The metadata associated with the content may comprise product information. The product information may indicate one or more products (e.g., items) in the content available for purchase. For example, the product information may include brand information associated with the one or more brand platforms 240. For example, the product information may include item identifiers. For example, a scene in the content may include a FENDI purse. The metadata associated with that scene may include brand information indicating FENDI is a brand associated with an item in the scene. The metadata may further indicate a product ID associated with the FENDI purse. Based on the product information, the client device may output one or more interface elements (e.g., via the interface module 222) indicating the item in the scene. The client device 220 may receive a user input via the one or more user interface elements. The user input may be configured to determine more information about the product in the scene and/or may be configured to purchase the product in the scene. Based on the product information, the client device 220 may cause one or more messages to be output via the interface module 222.

The interface module 222 may be configured to receive, send, store, analyze, generate, or otherwise process data. The interface module 222 may be configured to cause the user device to output one or more user interface elements. The one or more user interface elements may comprise video thumbnails, codes, QR codes, uniform resource locators (URLs), hyperlinks, still images, selectable options, combinations thereof, and the like. The one or more user interface elements may be associated with one or more retailers and/or with one or more products (e.g., items).

The interface module 222 may be configured to receive one or more user inputs. The one or more user inputs may comprise, for example, one or more selections, requests, queries, combinations thereof, and the like. For example, the interface module 222, based on displaying the one or more messages, may receive a purchase selection associated with an item in content.

The client device 220, may, based on the purchase selection, add an item associated with the purchase selection to a shopping cart (e.g., virtual shopping cart). The interface module 222 may be configured to output one or more fillable fields. For example, the interface module 222 may output a payment field configured to be populated (e.g., by a user) with financial information (e.g., credit card information). For example, a user can purchase a QVC or HSN product, however, can only purchase one product for one brand at a time. For example, a user is required to sign in and link their customer account (on qvc.com or hsn.com) to their streaming device one time per brand in order to complete a purchase within the streaming service.

The client device 220 may comprise a demodulator, decoder, frequency tuner, combinations thereof, and the like. The client device 220 may be directly connected to the network (e.g., for communications via in-band and/or out-of-band signals of a content delivery network) and/or connected to the network 260 via a communications module 223 (e.g., for communications via a packet switched network). The client device 220 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication module 223, a computer, a TV, a monitor, or a satellite dish. The communication module 223 may be located at a user location. The communication module 223 may be configured to communicate with the network 260. The communication module 223 may be a modem (e.g., cable modem), a router, a gateway, a switch, a network terminal (e.g., optical network unit), combinations thereof, and the like. The communication module 223 may be configured for communication with the network 216 via a variety of protocols, such as IP, transmission control protocol, file transfer protocol, session initiation protocol, voice over IP (e.g., VoIP), combinations thereof, and the like. The communication module 223, for a cable network, may be configured to facilitate network access via a variety of communication protocols and standards, such as Data Over Cable Service Interface Specification (DOCSIS).

The one or more streaming services 230 may comprise one or more services offering media services to users via the Internet. The one or more streaming services 230 may bypasses cable, broadcast, and satellite television platforms, the types of companies that act as controllers or distributors of such content. The one or more streaming services 230 may comprise one or more subscription-based video-on-demand (SVoD) services. The one or more streaming services 230 may offer access to film and television content (including existing series acquired from other producers, as well as original content produced specifically for the service) (e.g., the content). The one or more streaming services 230 may be accessed via websites on personal computers, via apps on mobile devices (such as smartphones and tablets), digital media players (including video game consoles), televisions with integrated Smart TV platforms, combinations thereof, and the like.

The one or more brand platforms 240 may comprise one or more markets where goods and services are available for purchase. For example, the one or more brand platforms may comprise one or more product databases including inventory information, pricing information, delivery information, purchase records, receipts, item descriptions, combinations thereof, and the like. The one or more brand platforms 240 may be managed by one or more brands and/or one or more third parties. The one or more brand platforms may be configured to maintain updated (e.g., regularly, in real-time) inventory information, pricing information, delivery information, purchase records, receipts, item descriptions, combinations thereof, and the like.

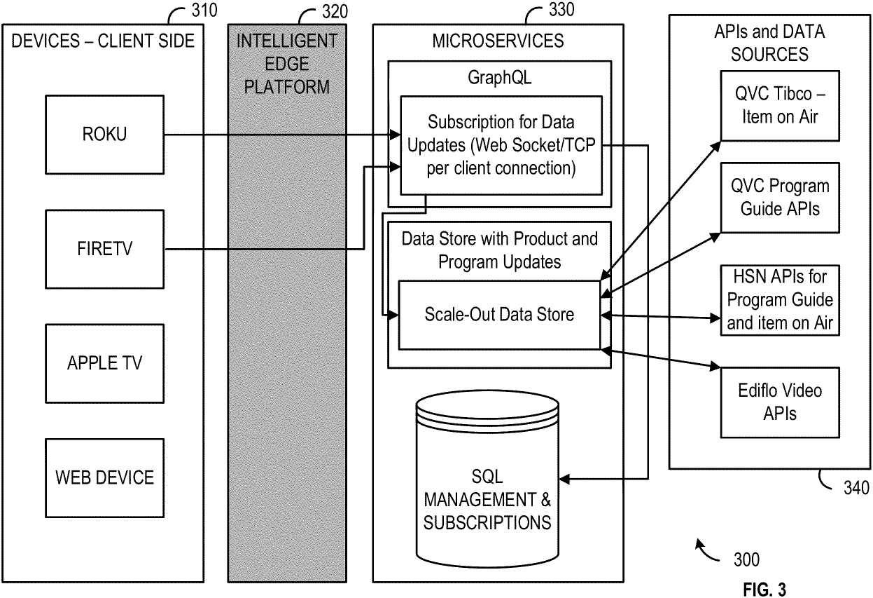

FIG. 3 shows an example system 300. The system 300 may comprise one or more client side devices 310, an intelligent edge platform 320, a microservices environment 330, and an APIs and Data Source 340. One or more client-side applications running on one or more client devices may connect to a microservices environment. For example, the one or more client devices may comprise one or more over-the-top applications 310 such as one or more streaming services (ROKU®, FIRETV®, HULU®, APPLE TV®, and other similar services). The one or more client devices may comprise one or more content sources as described above.

The one or more client-side applications may comprise one or more content item purchasing applications. The one or more content item purchasing applications may be configured to determine one or more items in content. The purchasing application may be configured to monitor the content stream to determine content segment IDs, then based on the content segments IDs, determines whether or not there is an item in the content segment available for purchase. The one or more items in content may comprise one or more items available for purchase from a third party seller. Determining one or more items in content may comprise determining item metadata associated with the content wherein the item metadata identifies an item for purchase in the content. For example, the item metadata may indicate a make, model, brand, manufacturer, seller, or other identifying information associated with the item in the content. The content may comprise one or more content segments. The item metadata may be associated with the content and/or with the one or more content segments.

The one or more OTT applications may be associated with one or more OTT application APIs. The one or more OTT application APIs may be associated with one or more OTT application API languages, schemas, architectures, data formats, data structures, combinations thereof, and the like. The GraphQL module may be configured to allow the microservices environment to define a structure of data required, and the same structure of the data is returned from the server, thereby preventing excessively large amounts of data from being returned.

The system may comprise an intelligent edge platform 320. The intelligent edge platform may comprise a decentralized edge platform configured for caching, traffic management, and security solutions.

The system may comprise a microservices environment 330. The microservices environment 330 may comprise a GraphQL module and a data store module. The GraphQL module may be configured with one or more subscriptions for data updates (e.g., web sockets/transmission control protocol per client connections). The GraphQL module may be configured to receive one or more queries from the one or more client-side devices. The microservices environment may be configured to, via the SQL Management & Subscriptions module, manage and manipulate relational databases. It is used to create, modify, and query databases, as well as to insert, update, and delete data. For example, the SQL Management & Subscriptions module may regularly query the one or more APIs and Data Sources to determine, for example, updated content and updated items. For example, the SQL Management & Subscriptions may determine content based on the QVC Program Guide APIs, the QVC Tibco Item on Air, or any other API or Data Source. Depending on the API and/or Data Source, the SQL Management & Subscriptions module may be configured for OCR and/or graphical XML. Graphical XML may be a visual representation of XML data. XML (extensible Markup Language). For example, the microservices environment 330 may be configured to determine graphics data in content and, based on the graphics data, determine data associated with one or more items for sale in the content. The microservices environment 330 may be configured to output one or more user interface elements configured to facilitate a purchase of the item in the content.

The microservices environment 330 may be configured to update subscription data. The subscription data may be associated with one or more subscribed clients. The microservices environement 330 may be configured to determine a change in an item in the content. For example content output may feature a first item and at a later time, a second item. For example, a resource locator or other identifier may be associated with the first item and the resource locator or other identifier may change when a second item is featured in the content. For example, a first content segment associated with a first item may be located at first URL configured to indicate the first item and a second content segment associated with a second item may be located at a different URL configured to indicate the second item. The aforementioned is merely exemplary and explanatory. The updated information may be determined via network trace, packet trace, packet capture, or the like. The network trace may comprise a record of the packets of data that flow through a computer network (e.g., the network 116, the network 260). The network trace may comprise a log of the network traffic that shows the sequence and content of the packets that are exchanged between devices on the network.

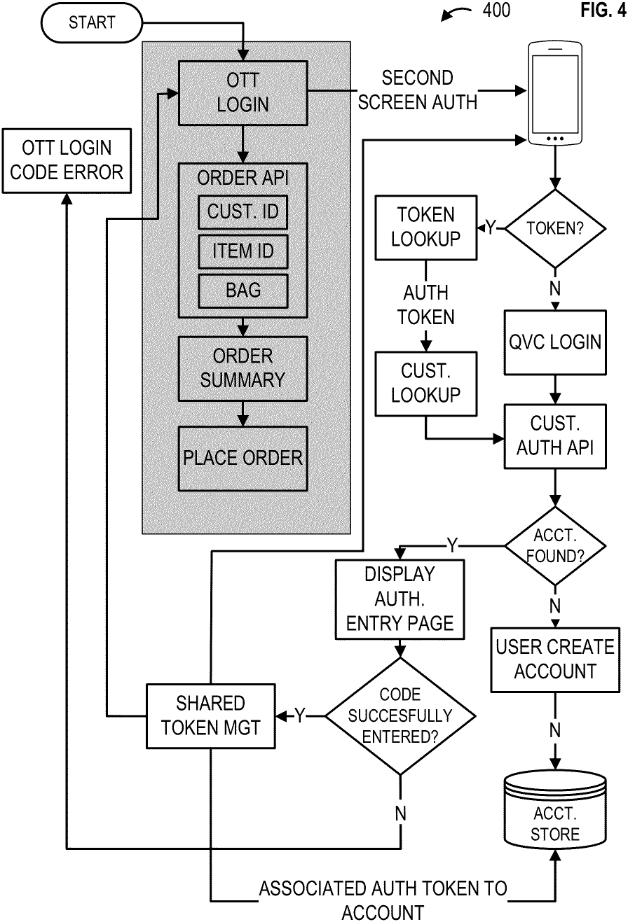

FIG. 4 shows an example account linking, authentication, and order placement method 400. A customer may initiate an authentication process. For example, the customer may, via one or more user interface elements, submit a user input configured to initiate a customer login process. The login process may comprise entering one or more user credentials. The one or more user credentials may comprise, for example, one or more of: a username, a user ID, a password, subscription information, accounting information, other identifying information, combinations thereof, and the like. The login process may be associated with an over-the-top (OTT) application. The one or more interface elements may be associated with a user device (e.g., a second screen device). For example, content may be displayed on a first screen such as a television or computer, and the login process credentials may be entered via one or more user interface elements output on a second screen such as a smart phone.

The authentication process may comprise a token lookup process. For example, an authorization device may determine if a token is associated with (e.g., present on) the user device. If the authentication device determines there is no token associated with the user device (and/or a user), the user may be directed to a login page. For example, a customer authorization application program interface (API) may be configured to determine whether or not a user has an account. If the customer has an account, the customer authorization API may cause the user device to display an authorization entry page. If the customer does not have an account, the customer authorization API may cause a “create account” page to display on the user device. The create account page may be configured to facilitate the creation of a customer account. The customer account may comprise (or otherwise be associated with) the one or more user credentials. The customer account may be stored in memory.

If the authentication device determines there is a token associated with the user device (and/or a user), the authentication device may use the token to determine the user via a customer lookup. Based on the customer lookup, the authentication device may cause the user device to display an entry page. The entry page may feature a customer code. The entry page may be configured to receive one or more user inputs. For example, the entry page may be configured to receive the customer code. The entry page may be configured to output one or more messages. For example, the entry page may be configured to output a prompt indicating a user may enter the customer code. Upon successful entry of the customer code, a shared token authority may send a token to the user device and to the OTT application. The OTT application may receive the token and cause output of one or more interface elements configured to facilitate one or more purchases. For example, an interface element may comprise a selectable option to add an item to a shopping cart.

A user may, via a user interface, select the selectable option and thereby add the item the shopping cart. The item may be an item in content associated with the OTT application. For example, the item may be associated with a segment of content. For example, metadata associated with the segment of content may indicate the segment of content comprises (e.g., features) an item capable of being purchased. Upon adding the item to the shopping cart, a prompt may be displayed wherein the prompt is configured to facilitate a purchase of the item. For example, the prompt may comprise a purchase interface configured to receive (e.g., either from storage or via user input), financial information such as credit information to facilitate placing an order for the item in the shopping cart.

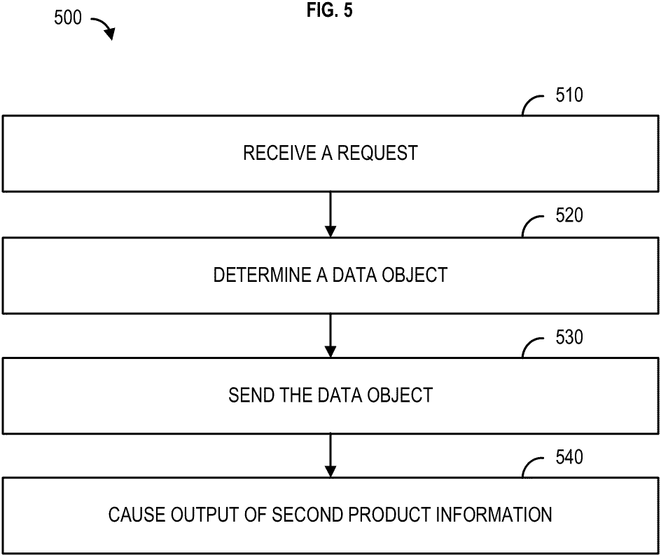

FIG. 5 shows a flowchart of a method 500 for content management. The method 500 may be carried out on any one or more of the devices described in FIGS. 1A-1B, FIG. 2, FIG. 3, FIG. 4 and/or FIG. 5. At 510, a request may be received. The request may comprise first product information and first platform information in content. The content may be received by a streaming service application from a content source. The request may be associated with a streaming service application format. The content may comprise one or more of: live content or video on demand content. The content may comprise the first product information. The first product information may be associated with one or more of: a frame of content, a timestamp, a packet of content, metadata associated with the content, or a programming guide. The first product information may indicate one or more of: a brand, a model, an item, a product code, an item number, combinations thereof, and the like.

At 520, a data object may be determined. The data object may comprise second product information. The second product information may comprise one or more of: a price, an availability, a purchase option, or a resource locator.

At 530, the data object may be sent. The data object may comprise second product information. The data object may comprise a data packet. The data object may be associated with one or more user interface elements. The one or more user interface elements may be associated with one or more retailers (e.g., one or more third party sellers). The data object may be associated with the first product information. The data object may be configured according to a common schema.

At 540, a purchase can be caused to be executed. The purchase can be executed based on the second product information. For example, the data object configured according to the common schema can be sent to a retailer. The data object may comprise product information and financial information and may be configured to purchase an item associated with the first product information.

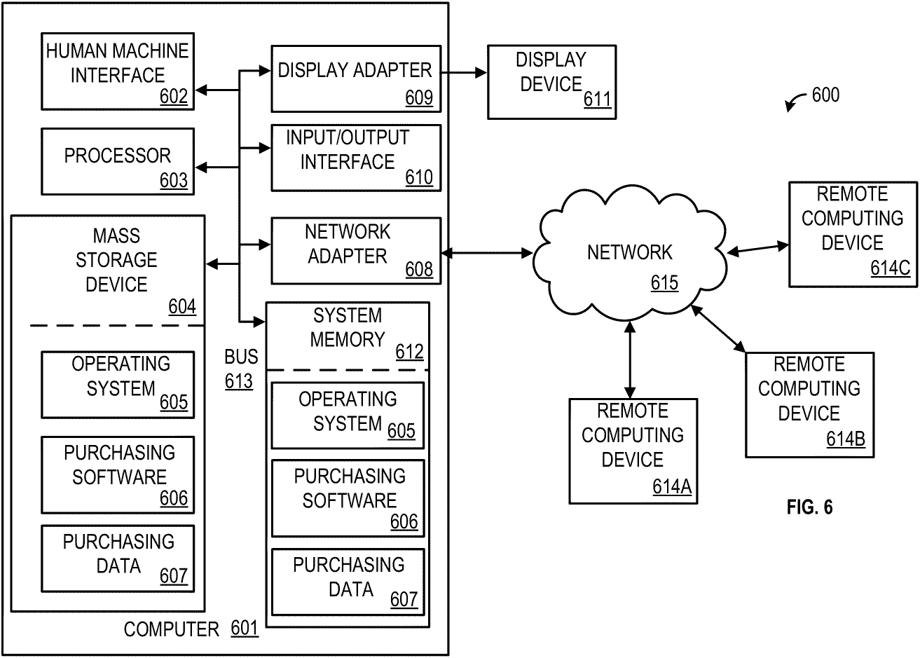

FIG. 6 shows a system 600 for content management. The computer 601 may comprise one or more processors 603, a system memory 612, and a bus 613 that couples various system components including the one or more processors 603 to the system memory 612. In the case of multiple processors 603, the computer 601 may utilize parallel computing. The bus 613 is one or more of several possible types of bus structures, including a memory bus or memory controller, a peripheral bus, an accelerated graphics port, or local bus using any of a variety of bus architectures.

The computer 601 may operate on and/or comprise a variety of computer readable media (e.g., non-transitory). The readable media may be any available media that is accessible by the computer 601 and may comprise both volatile and non-volatile media, removable and non-removable media. The system memory 612 has computer readable media in the form of volatile memory, such as random access memory (RAM), and/or non-volatile memory, such as read only memory (ROM). The system memory 612 may store data such as the product data 607 and/or program modules such as the operating system 605 and the product software 606 that are accessible to and/or are operated on by the one or more processors 603. The machine learning module may comprise one or more of the product data 607 and/or the product software 606.

The computer 601 may also comprise other removable/non-removable, volatile/non-volatile computer storage media. FIG. 6 shows the mass storage device 604 which may facilitate non-volatile storage of computer code, computer readable instructions, data structures, program modules, and other data for the computer 601. The mass storage device 604 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 604, such as the operating system 605 and the product software 606. Each of the operating system 605 and the product software 606 (or some combination thereof) may comprise elements of the program modules and the product software 606. The product data 607 may also be stored on the mass storage device 604. The product data 607 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 615.

A user may enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 603 via a human machine interface 602 that is coupled to the bus 613, but may be connected by other interface and bus structures, such as a parallel port, game port, an IEEE 1394 Port (also known as a Firewire port), a serial port, network adapter 608, and/or a universal serial bus (USB).

The display device 611 may also be connected to the bus 613 via an interface, such as the display adapter 609. It is contemplated that the computer 601 may comprise more than one display adapter 609 and the computer 601 may comprise more than one display device 611. The display device 611 may be a monitor, an LCD (Liquid Crystal Display), light emitting diode (LED) display, television, smart lens, smart glass, and/or a projector. In addition to the display device 611, other output peripheral devices may be components such as speakers (not shown) and a printer (not shown) which may be connected to the computer 601 via the Input/Output Interface 610. Any step and/or result of the methods may be output (or caused to be output) in any form to an output device. Such output may be any form of visual representation, including, but not limited to, textual, graphical, animation, audio, tactile, and the like. The display device 611 and computer 601 may be part of one device, or separate devices.

The computer 601 may operate in a networked environment using logical connections to one or more remote computing devices 614A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 601 and a remote computing device 614A,B,C may be made via a network 615, such as a local area network (LAN) and/or a general wide area network (WAN). Such network connections may be through the network adapter 608. The network adapter 608 may be implemented in both wired and wireless environments. Such networking environments are conventional and commonplace in dwellings, offices, enterprise-wide computer networks, intranets, and the Internet.

Application programs and other executable program components such as the operating system 605 are shown herein as discrete blocks, although it is recognized that such programs and components reside at various times in different storage components of the computing device 601, and are executed by the one or more processors 603 of the computer. An implementation of the product software 606 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, based on content received by a client device comprising first product information, a request, wherein the request comprises the first product information and platform information;
determining, based on the request and the first product information, a data object comprising second product information, wherein the data object is configured according to a common schema;
sending, based on the request, the data object, wherein the data object is associated with one or more user interface elements and wherein the one or more user interface elements are associated with the platform information; and
causing, based on the data object configured according to the common schema and the second product information, a purchase to be executed.

2. The method of claim 1, wherein the client device comprises one or more of: a smartphone, a laptop, a set-top-box, a gateway device, a computer, a smart speaker, a television, combinations thereof, and the like.

3. The method of claim 1, wherein the content comprises one or more of: streaming content, video-on-demand (VOD) content, one or more advertisements, or metadata.

4. The method of claim 1, wherein the first product information is configured to indicate a product featured in the content and wherein the second product information comprises one or more of: product availability information, pricing information, discount information, store location information, third party seller information, or shipping information.

5. The method of claim 1, wherein sending the data object comprises sending the data object to a requesting client device.

6. The method of claim 1, wherein the common schema comprises a typed defined schema.

7. The method of claim 1, further comprising causing the one or more interface elements to output the second product information.

8. An apparatus comprising:
one or more processors; and
a memory storing processor executable instructions that, when executed by the one or more processors, cause the apparatus to:
receive, based on content received by a client device comprising first product information, a request, wherein the request comprises the first product information and platform information;
determine, based on the request and the first product information, a data object comprising second product information, wherein the data object is configured according to a common schema;
send, based on the request, the data object, wherein the data object is associated with one or more user interface elements and wherein the one or more user interface elements are associated with the platform information; and
cause, based on the data object configured according to the common schema and the second product information, a purchase to be executed.

9. The apparatus of claim 8, wherein the client device comprises one or more of: a smartphone, a laptop, a set-top-box, a gateway device, a computer, a smart speaker, a television, combinations thereof, and the like.

10. The apparatus of claim 8, wherein the content comprises one or more of: streaming content, video-on-demand (VOD) content, one or more advertisements, or metadata.

11. The apparatus of claim 8, wherein the first product information is configured to indicate a product featured in the content and wherein the second product information comprises one or more of: product availability information, pricing information, discount information, store location information, third party seller information, or shipping information.

12. The apparatus of claim 8, wherein the processor executable instructions are further configured to cause the apparatus to send the data object to a requesting client device.

13. The apparatus of claim 8, wherein the common schema comprises a typed defined schema.

14. The apparatus of claim 8, wherein the processor executable instructions are further configured to cause the one or more interface elements to output the second product information.

15. One or more non-transitory computer readable media storing processor executable instructions that, when executed by at least one processor, cause the at least one processor to:
receive, based on content received by a client device comprising first product information, a request, wherein the request comprises the first product information and platform information;
determine, based on the request and the first product information, a data object comprising second product information, wherein the data object is configured according to a common schema;
send, based on the request, the data object, wherein the data object is associated with one or more user interface elements and wherein the one or more user interface elements are associated with the platform information; and
cause, based on the data object configured according to the common schema and the second product information, a purchase to be executed.

16. The one or more non-transitory computer readable media of claim 15, wherein the client device comprises one or more of: a smartphone, a laptop, a set-top-box, a gateway device, a computer, a smart speaker, a television, combinations thereof, and the like.

17. The one or more non-transitory computer readable media of claim 15, wherein the content comprises one or more of: streaming content, video-on-demand (VOD) content, one or more advertisements, or metadata.

18. The one or more non-transitory computer readable media of claim 15, wherein the first product information is configured to indicate a product featured in the content and wherein the second product information comprises one or more of: product availability information, pricing information, discount information, store location information, third party seller information, or shipping information.

19. The one or more non-transitory computer readable media of claim 15, wherein the common schema comprises a typed defined schema.

20. The one or more non-transitory computer readable media of claim 15, wherein the processor executable instructions are further configured to cause the at least one processor to cause the one or more interface elements to output the second product information.
